(19) United States
(12) Patent Application Publication
(10) Pub. No.: US 2022/0069339 A1
(43) Pub. Date: Mar. 3, 2022

(54) LITHIUM METAL SECONDARY BATTERY

(71) Applicant: Panasonic Intellectual Property Management Co., Ltd., Osaka-shi, Osaka (JP)

(72) Inventors: Tomohisa Okazaki, Osaka (JP); Akira Kano, Osaka (JP)

(73) Assignee: Panasonic Intellectual Property Management Co., Ltd., Osaka-shi, Osaka (JP)

(21) Appl. No.: 17/424,778

(22) PCT Filed: Dec. 4, 2019
(86) PCT No.: PCT/JP2019/047412

§ 371 Date: Jul. 21, 2021

(30) Foreign Application Priority Data
Jan. 31, 2019 (JP) 2019-015362

(51) Int. Cl. H01M 10/0525; H01M 10/0567; H01M 4/134; H01M 4/131; H01M 4/66; H01M 4/38; H01M 4/28

(52) U.S. Cl. CPC H01M 10/0525; H01M 10/0567; H01M 4/134; H01M 4/28; H01M 4/662; H01M 4/382; H01M 4/131

(57) ABSTRACT

A lithium metal secondary battery includes: a positive electrode including a positive electrode active material which contains a lithium transition metal oxide; a negative electrode which is disposed to face the positive electrode, which includes a negative electrode collector, and on which a lithium metal is precipitated in charge; a separator provided between the positive electrode and the negative electrode; and an electrolyte which is impregnated in the separator and which contains a lithium halogenated compound in an amount of more than 0.1 to less than 10 percent by weight and at least one selected from a fluorinated cyclic carbonate and a fluorinated oxalate complex.

### TECHNICAL FIELD

The present disclosure relates to an improvement in discharge capacity retention rate of a lithium metal secondary battery.

### BACKGROUND ART

As a high capacity secondary battery, a lithium ion secondary battery has been known. In the lithium ion secondary battery, for example, as a negative electrode active material, a carbon material or a Si material is used. Those negative electrode active materials each reversibly occlude and release lithium ions to perform charge/discharge.

On the other hand, in order to further increase the capacity, a lithium metal secondary battery (lithium secondary battery) which uses a lithium metal as a negative electrode active material is promising. In the lithium metal secondary battery, a lithium metal is precipitated on a negative electrode collector in a charge process, and the precipitated lithium metal is dissolved in an electrolyte in a discharge process, so that the charge/discharge is repeatedly performed. Since a lithium metal has a significantly base potential, the lithium metal secondary battery is expected to realize a high theoretical capacity density.

However, in the lithium metal secondary battery, a lithium metal is liable to be precipitated in a dendrite shape, and this precipitation mode is difficult to control. When a lithium metal is precipitated in a dendrite shape, a specific surface area of a negative electrode is increased, and a contact area thereof with an electrolyte is increased, so that a side reaction with the electrolyte is promoted. By this side reaction, inactive lithium having no contribution to the charge/discharge is generated, and as a result, a decrease in discharge capacity may arise.

Patent Document 1 has disclosed that an additive, such as lithium iodide, capable of being oxidized and reduced in an operating voltage range of a battery is added to an electrolyte. When a lithium metal precipitated on a negative electrode is electrically insulated from the negative electrode and has no contribution to charge/discharge, this additive enables this lithium metal having no contribution to charge/discharge to be ionized by oxidation, and as a result, degradation in charge/discharge cycle characteristics is prevented.

### CITATION LIST

### Patent Literature

Patent Document 1: Japanese Published Unexamined Patent Application No. 2003-243030

### SUMMARY OF INVENTION

However, according to the method disclosed in Patent Document 1, the dendrite-shaped precipitation of the lithium metal itself cannot be suppressed, and in association with the repetition of charge/discharge, the decrease in discharge capacity retention rate occurs.

According to one aspect of the present invention, there is provided a lithium metal secondary battery comprising: a positive electrode including a positive electrode active material which contains a lithium transition metal oxide; a negative electrode which is disposed to face the positive electrode, which includes a negative electrode collector, and on which a lithium metal is precipitated in charge; a separator disposed between the positive electrode and the negative electrode; and an electrolyte which is impregnated in the separator and which contains a lithium halogenated compound in an amount of more than 0.1 to less than 10 percent by weight and at least one selected from a fluorinated cyclic carbonate and a fluorinated oxalate complex.

According to the lithium metal secondary battery of the present disclosure, the decrease in discharge capacity retention rate caused by the dendrite-shaped precipitation of a lithium metal can be suppressed.

### BRIEF DESCRIPTION OF DRAWINGS

FIG. 1 is a view schematically showing a charge/discharge state of a lithium metal secondary battery according to this embodiment.

FIG. 2 is a longitudinal cross-sectional view of the lithium metal secondary battery according to this embodiment.

### DESCRIPTION OF EMBODIMENTS

Hereinafter, with reference to the drawings, embodiments will be described in detail. However, an unnecessary detailed description may be omitted in some cases. For example, a detailed description on a well-known matter and/or a duplicated description on substantially the same structure may be omitted. The reason for this is to avoid the following description from being unnecessarily redundant and to facilitate the understanding of a person skilled in the art. In addition, the accompanying drawings and the following description are provided to enable a person skilled in the art to sufficiently understand the present disclosure and are not intended to restrict the subject described in the claims.

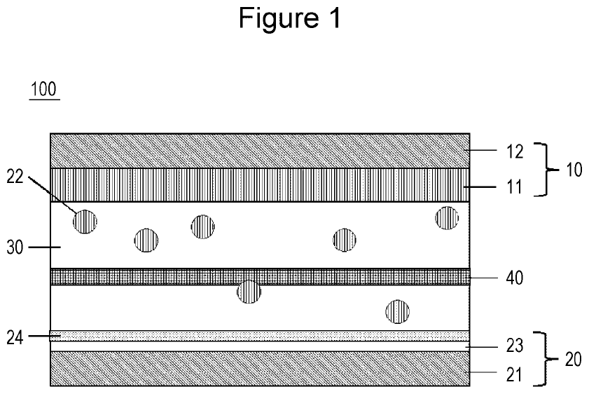

FIG. 1 is a schematic view showing a charge state of a lithium metal secondary battery according to an embodiment of the present disclosure. A lithium metal secondary battery 100 includes a positive electrode 10, a negative electrode 20, an electrolyte 30, and a separator 40 which is disposed between the positive electrode 10 and negative electrode 20 and through which lithium ions permeate. The positive electrode 10 includes a positive electrode mixture layer 11 containing a positive electrode active material and a positive electrode collector 12. The negative electrode 20 includes a negative electrode collector 21. The electrolyte 30 is impregnated in the separator 40 and contains a lithium halogenated compound in an amount of more than 0.1 to less than 10 percent by weight and at least one selected from a fluorinated cyclic carbonate and a fluorinated oxalate complex.

When the lithium metal secondary battery 100 is charged, as shown in FIG. 1, lithium contained in the positive electrode active material is released as lithium ions 22 from the positive electrode 10. Subsequently, the lithium ions 22 are precipitated as a lithium metal 23 on the surface of the negative electrode collector 21. In discharge, the lithium metal 23 is dissolved and changed into the lithium ions 22 and is occluded in the positive electrode active material. Since the fluorinated cyclic carbonate and/or the fluorinated oxalate complex is added to the electrolyte 30, in association with the charge, on the surface of the negative electrode collector 21 or the surface of the lithium metal 23 thus precipitated, a fluorine-containing film 24 is formed.

In the present invention, since the lithium halogenated compound in an amount of more than 0.1 to less than 10 percent by weight and the fluorinated cyclic carbonate and/or the fluorinated oxalate complex are added to the electrolyte, a dendrite precipitation of the lithium metal is prevented, and the decrease in discharge capacity retention rate can be suppressed. Although the detailed reason for this is not known at this moment, the following is considered.

In a lithium metal secondary battery in which in charge, a lithium metal is precipitated on a negative electrode, a tree branch-like precipitate (dendrite precursor) is to be generated on a negative electrode collector. By using this dendrite precursor as a nucleus, a dendrite-shaped precipitate of the lithium metal extends. When a fluorinated cyclic carbonate and/or a fluorinated oxalate complex is added to an electrolyte, a fluorine-containing film, such as LiF, is formed on a negative electrode surface. When the film is formed, the lithium metal is precipitated between the film and the negative electrode collector and is pressed by the film. By this press effect, the generation of the dendrite precursor and the extension of the dendrite-shaped precipitate are believed to be suppressed.

In addition, the fluorine-containing films derived from the fluorinated cyclic carbonate and the fluorinated oxalate complex each have a structural flexibility. Hence, when the dendrite precursor and the like are dissolved by the lithium halogenated compound which will be described later, the fluorine-containing film is able to follow the change of the surface shape thereof. That is, the film is placed in a state of always being in contact with the dendrite precursor and the dendrite-shaped precipitate, and hence, the press effect is likely to be obtained.

In the charge, the generation of the dendrite precursor and the formation of the fluorine-containing film simultaneously proceed in parallel. Hence, before the fluorine-containing film is formed on the negative electrode surface, the dendrite precursor may be formed in some cases. When the dendrite precursor is generated, and the dendrite-shaped precipitate starts to extend, the formation of the film is not able to follow this extension, and as a result, the dendrite-shaped precipitate is not likely to be suppressed.

In the case described above, when the lithium halogenated compound in an amount of more than 0.1 to less than 10 percent by weight is added to the electrolyte, by a redox reaction, the dendrite precursor can be dissolved. Hence, even if the dendrite precursor is generated on the negative electrode surface, by the lithium halogenated compound, the dendrite precursor is dissolved, and the lithium metal surface is further planarized. In addition, since the lithium halogenated compound also dissolves the dendrite-shaped precipitate, the extension of the dendrite-shaped precipitate can also be suppressed. By the lithium halogenated compound, the generation of the dendrite precursor and the extension of the dendrite-shaped precipitate are suppressed, and during this suppression, a sufficient amount of the fluorine-containing film is formed; hence, the press effect by the film described above can be more likely to be obtained. Accordingly, since the lithium halogenated compound is used together with the fluorinated cyclic carbonate and/or the fluorinated oxalate complex, by the synergetic effect therebetween, the generation of the dendrite precursor and the extension of the dendrite-shaped precipitate can be suppressed. Hence, a more uniform lithium metal surface is formed on the negative electrode collector surface, and the decrease in discharge capacity retention rate can be suppressed.

Hereinafter, constituent elements of the lithium metal secondary battery will be respectively described in detail.

[Electrolyte]

The electrolyte contains a solvent, an electrolyte salt dissolved in the solvent, a lithium halogenated compound in an amount of more than 0.1 to less than 10 percent by weight with respect to the total of the electrolyte, and a fluorinated cyclic carbonate and/or a fluorinated oxalate complex. As the solvent, a nonaqueous solvent may be used, and an aqueous solvent may also be used. In addition, the electrolyte is not limited to a liquid electrolyte (electrolyte liquid), and a solid electrolyte using a gel polymer or the like may also be used.

The lithium halogenated compound is likely to be dissolved in the electrolyte and is stable as an oxidant and as a reductant in a battery operating voltage range. Since being stable, the lithium halogenated compound is not likely to be decomposed and is also not likely to react with the electrolyte and the electrode surface, and as a result, a charge/discharge reaction is not likely to be disturbed.

When the lithium halogenated compound is contained in an amount of more than 0.1 to less than 10 percent by weight with respect to the total of the electrolyte, the dissolution of the dendrite precursor and the like is efficiently performed. A content of the lithium halogenated compound is more preferably 0.5 to 3 percent by weight. When the content of the lithium halogenated compound is more than 0.1 percent by weight, the dendrite precursor and the like can be sufficiently dissolved in the electrolyte. When the content described above is less than 10 percent by weight, excessive dissolution of a lithium metal uniformly precipitated on the negative electrode is prevented, and hence, a self-discharge is suppressed.

The lithium halogenated compound is preferably at least one selected from lithium chloride, lithium bromide, and lithium iodide. Among those mentioned above, since an oxidant and a reductant which react at respective potentials of the positive electrode and the negative electrode are stably present, lithium bromide or lithium iodide is more preferable.

When the fluorinated cyclic carbonate and/or the fluorinated oxalate complex is added to the electrolyte, a film is formed on the surface of the negative electrode collector or the surface of the lithium metal thus precipitated. By the press effect of the film, the generation of the dendrite precursor and the extension of the dendrite-shaped precipitate can be suppressed.

With respect to the volume of the electrolyte, the fluorinated cyclic carbonate is added preferably in an amount of 8 to 30 percent by volume and more preferably in an amount of 10 to 25 percent by volume. When the fluorinated cyclic carbonate is added in an amount of 8 percent by volume or more, the film can be formed in an amount sufficient to suppress the generation of the dendrite precursor and the like. When the fluorinated cyclic carbonate is added in an amount of 30 percent by volume or less, a film resistance is not excessively increased, and hence, the charge/discharge can be efficiently performed.

As the fluorinated cyclic carbonate, a fluoroethylene carbonate or a derivative thereof is preferably used. As the fluoroethylene carbonate, for example, 4-fluoroethylene carbonate, 4,5-difluoroethylene carbonate, 4,4-difluoroethylene carbonate, or 4,4,5-trifluoroethylene carbonate may be mentioned.

With respect to the total of the electrolyte, the fluorinated oxalate complex is added preferably in an amount of 0.01 to 1 mol/L and more preferably in an amount of 0.3 to 0.7 mol/L.

As the fluorinated oxalate complex, for example, there may be mentioned lithium difluoro(oxalate)borate (LiBF₂(C₂O₄)), lithium tetrafluoro(oxalate)phosphate (LiPF₄(C₂O₄)), or lithium difluorobis(oxalate)phosphate (LiPF₂(C₂O₄)₂). Those fluorinated oxalate salts each also function as an electrolyte salt.

As the electrolyte salt, a lithium salt may be used. Since the lithium salt is dissolved in the solvent, lithium ions and anions are generated.

As the lithium salt, a lithium salt which has been generally used as a supporting salt in a related lithium ion secondary battery or lithium metal secondary battery may be used. In particular, for example, there may be mentioned LiBF₄, LiClO₄, LiPF₆, LiAsF₆, LiCF₃SO₃, LiCF₃CO₂, an imide, or an oxalate complex. As an imide salt, for example, there may be mentioned LiN(FSO₂)₂, LiN(C₁F₂₁₊₁SO₂)(CₘF₂ₘ₊₁SO₂) (l and m each indicate an integer equal to or more than 1), or LiC(CPF₂ₚ₊₁SO₂) (C_{q}F_{2q+1}SO₂) (CᵣF₂ᵣ₊₁SO₂) (p, q, and r each indicate an integer equal to or more than 1). As the oxalate complex, lithium bis(oxalate)borate (LiB(C₂O₄)₂) may be used. Those lithium salts mentioned above may be used alone, or at least two types thereof may be used in combination.

As the nonaqueous solvent, for example, an ester, an ether, a nitrile, an amide or a halogen substitute thereof may be mentioned. In the electrolyte, one of those nonaqueous solvents may be contained, or at least two types thereof may be contained. As the halogen substitute, for example, a fluoride may be mentioned.

As the ester, for example, a carbonate ester or a carboxylic acid ester may be mentioned. As a cyclic carbonate ester, for example, ethylene carbonate or propylene carbonate may be mentioned. As a chain carbonate ester, for example, dimethyl carbonate (DMC), ethyl methyl carbonate (EMC), or diethyl carbonate may be mentioned. As a cyclic carboxylic acid ester, for example, γ-butyrolactone or γ-valerolactone may be mentioned. As a chain carboxylic acid ester, for example, methyl acetate, ethyl acetate, methyl propionate, or methyl fluoropropionate may be mentioned.

As the ether, a cyclic ether and a chain ether may be mentioned. As the cyclic ether, for example, 1,3-dioxolane, 4-methyl-1,3-dioxalane, tetrahydrofuran, or 2-methyltetrahydrofuran may be mentioned. As the chain ether, for example, there may be mentioned 1,2-dimethoxyehtane, diethyl ether, ethyl vinyl ether, methyl phenyl ether, benzyl ethyl ether, diphenyl ether, dibenzyl ether, 1,2-diethoxyethane, or diethylene glycol dimethyl ether.

The electrolyte may also contain at least one additive other than those described above. An additive forming a film on the negative electrode may also be used. As the additive described above, for example, vinylene carbonate or vinyl ethyl carbonate may be mentioned.

[Negative Electrode]

The negative electrode includes a negative electrode collector. In the lithium metal secondary battery, for example, on a surface of the negative electrode collector, a lithium metal is precipitated by charge. In more particular, when receiving electrons on the negative electrode collector by charge, lithium ions contained in the electrolyte are changed into a lithium metal and precipitated on the surface of the negative electrode collector. The lithium metal precipitated on the surface of the negative electrode collector is dissolved in the electrolyte in the form of lithium ions by discharge. In addition, the lithium ions contained in the electrolyte may be derived from a lithium salt added to the electrolyte, may be supplied from the positive electrode active material by the charge, or may also be supplied from the above two sources.

In view of the increase in capacity, the negative electrode includes the negative electrode collector, and on the negative electrode collector immediately after battery assembly, the negative electrode active material and the lithium metal are preferably not formed. In the case described above, the thickness of the lithium metal to be precipitated on the negative electrode collector in a first discharge is preferably 15 μm or less. Even when the charge/discharge is repeatedly performed, in a fully discharged state, the thickness of the lithium metal precipitated on the negative electrode collector is preferably 30 μm or less. Since no negative electrode active material which occludes lithium ions is used, a high energy density can be obtained. In addition, in order to uniformly precipitate the lithium metal, a lithium metal having a thickness of approximately 10 μm may be formed in advance on the negative electrode collector.

As the negative electrode collector, an electrically conductive sheet may be used. As the electrically conductive sheet, for example, foil or a film may be used.

The surface of the electrically conductive sheet may be flat. Accordingly, in the charge, a lithium metal derived from the positive electrode is likely to be uniformly precipitated on the electrically conductive sheet. The flatness indicates that the maximum height roughness Rz of the electrically conductive sheet is 20 μm or less. The maximum height roughness Rz may also be 10 μm or less. The maximum height roughness Rz is measured in accordance with JISB0601:2013.

As a material of the negative electrode collector (electrically conductive sheet), any electrically conductive material, such as a metal or an alloy, other than a lithium metal or a lithium alloy may be used. The electrically conductive material is preferably a material which will not react with lithium. In more particular, a material which forms neither an alloy nor an intermetallic compound with lithium is preferable. As the electrically conductive material described above, for example, there may be mentioned copper (Cu), nickel (Ni), iron (Fe), an alloy containing at least one of those metal elements mentioned above, or a graphite in which the basal surface is preferentially exposed. As the alloy, for example, a copper alloy or stainless steel (SUS) may be mentioned. Among those mentioned above, since a reaction with the lithium halogenated compound is not likely to occur, copper and/or a copper alloy, each of which has a high electrical conductivity, is preferable.

A thickness of the negative electrode collector is not particularly limited and is, for example, 5 to 300 μm.

On the surface of the negative electrode collector, a negative electrode mixture layer may be formed. The negative electrode mixture layer may be formed such that, for example, a paste containing a carbon material such as a graphite and a negative electrode active material such as a Si material is applied on at least a part of the surface of the negative electrode collector. However, in order to achieve a higher capacity than that of a lithium ion battery, a thickness of the negative electrode mixture layer is preferably set to be sufficiently thin so that a lithium metal is able to be precipitated on the negative electrode.

[Positive Electrode]

The positive electrode includes a positive electrode collector, and a positive electrode mixture layer supported by the positive electrode collector. The positive electrode mixture layer contains, for example, a positive electrode active material, an electrically conductive material, and a binding material. The positive electrode mixture layer may be formed on only one surface of the positive electrode collector or on each of two facing surfaces thereof. The positive electrode can be obtained such that, for example, after a positive electrode mixture slurry containing the positive electrode active material, the electrically conductive material, and the binding material is applied on the two facing surfaces of the positive electrode collector, the coating films thus formed are dried and then rolled.

The positive electrode active material is a material which occludes and releases lithium ions. As the positive electrode active material, for example, there may be mentioned a lithium transition metal oxide, a transition metal fluoride, a polyaniline, a fluorinated polyaniline, or a transition metal sulfide. Among those mentioned above, since a manufacturing cost is low, and an average discharge voltage is high, the lithium transition metal oxide is preferable.

In the charge, the lithium contained in the lithium transition metal oxide is released as lithium ions from the positive electrode and is precipitated as a lithium metal on the negative electrode. In the discharge, since the lithium metal is dissolved from the negative electrode, lithium ions are released therefrom and occluded in the composite oxide of the positive electrode. That is, almost all the lithium ions involved in the charge/discharge are derived from the electrolyte salt in the electrolyte and the positive electrode active material. Hence, for example, when the lithium transition metal oxide has a layered structure, a molar ratio M_{Li}/M_{TM} of a total molar amount M_{Li} of lithium in the positive electrode and the negative electrode to a molar amount M_{TM} of a metal M in the positive electrode may be, for example, 1.1 or less.

As the lithium transition metal oxide, for example, there may be mentioned LiₐCoO₂, LiₐNiO₂, LiₐMnO₂, LiₐCo_{b}Ni_{1-b}O₂, LiₐCo_{b}M_{1-b}O_{c}, LiₐNi_{1-b}M_{b}O_{c}, LiₐMn₂O₄, LiₐMn_{2-b}M_{b}O₄, LiMePO₄, or Li₂MePO₄F. In the case described above, M is at least one selected from the group consisting of Na, Mg, Ca, Zn, Ga, Ge, Sn, Sc, Ti, V, Cr, Y, Zr, W, Mn, Fe, Co, Ni, Cu, Zn, Al, Cr, Pb, Sb, Bi and B. Me at least contains a transition metal (for example, contains at least one selected from the group consisting of Mn, Fe, Co, and Ni). 0≤a≤1.2, 0≤b≤0.9, and 2.0≤c≤2.3 are satisfied. In addition, the a value indicating the molar ratio of lithium is a value in a discharged state corresponding to the value immediately after the active material formation and is increased and decreased by the charge/discharge.

In the lithium transition metal oxide, as the transition metal element, at least one selected from Co, Ni, and Al is preferably contained. As an arbitrary component, Mn may also be contained. In addition, in order to obtain a high capacity, a composite oxide having a layered rock salt type crystalline structure is preferable.

The electrically conductive material is, for example, a carbon material. As the carbon material, for example, a carbon black, an acetylene black, a Ketjen black, carbon nanotubes, and a graphite may be mentioned.

As the binding material, for example, a fluorine resin, a polyacrylonitrile, a polyimide resin, an acrylic resin, a polyolefin resin, or a rubber-like polymer may be mentioned. As the fluorine resin, for example, a polytetrafluoroethylene or a poly(vinylidene fluoride) may be mentioned.

As the positive electrode collector, an electrically conductive sheet may be used. As the electrically conductive sheet, for example, foil or a film may be used. On a surface of the positive electrode collector, a carbon material may be applied.

As a material of the positive electrode collector (electrically conductive sheet), for example, a metal material, such as Al, Ti, or Fe, may be mentioned. The metal material may also be Al, an Al alloy, Ti, a Ti alloy, or an Fe alloy. The Fe alloy may also be stainless steel (SUS).

A thickness of the positive electrode collector is not particularly limited and is, for example, 5 to 300 μm.

[Separator]

The separator may be provided between the positive electrode and the negative electrode. As the separator, a porous sheet having an ion permeability and an insulating property is used. As the porous sheet, for example, a thin film, a woven cloth, or a non-woven cloth, each having fine pores may be mentioned. Although not particularly limited, a material of the separator may be a high molecular weight material. As the high molecular weight material, for example, an olefin resin, a polyamide resin, or a cellulose may be mentioned. As the olefin resin, a polyethylene, a polypropylene, or a copolymer of ethylene and propylene may be mentioned. The separator may contain additives, if needed. As the additives, in order to improve the strength of the separator, for example, an inorganic filler may be mentioned. On a separator surface, a heat-resistant layer containing an inorganic filler may be formed.

[Lithium Secondary Battery]

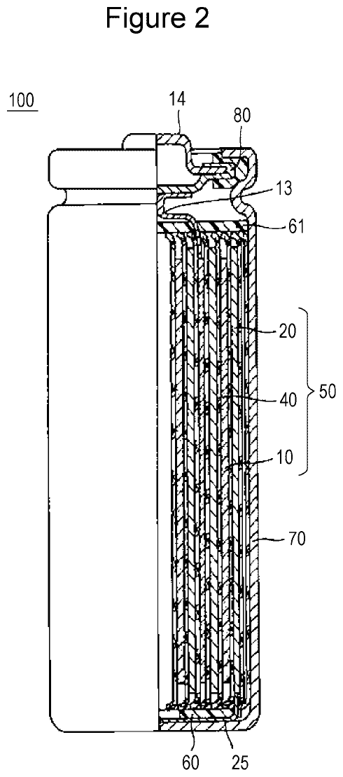

FIG. 2 is a longitudinal cross-sectional view of one example of a cylindrical lithium secondary battery according to one embodiment of the present invention.

A lithium metal secondary battery 100 is a winding type battery including a winding type electrode group 50 and an electrolyte not shown. The winding type electrode group 50 includes a belt-shaped positive electrode 10, a belt-shaped negative electrode 20, and at least one separator 40. A positive electrode lead 13 is connected to the positive electrode 10, and a negative electrode lead 25 is connected to the negative electrode 20.

One end portion of the positive electrode lead 13 in a longitudinal direction is connected to the positive electrode 10, and the other end portion thereof is connected to a sealing plate 80. The sealing plate 80 includes a positive electrode terminal 14. One end of the negative electrode lead 25 is connected to the negative electrode 20, and the other end thereof is connected to a bottom portion of a battery case 70 functioning as a negative electrode terminal. The battery case 70 is a cylindrical bottom-closed battery can in which one end in a longitudinal direction is opened, and a bottom portion at the other end functions as the negative electrode terminal. The battery case (battery can) 70 is made of a metal and is made, for example, of iron. An inner surface of the iron-made battery case 70 is, in general, nickel-plated. At a top and a bottom of the winding type electrode group 50, an upper insulating ring 61 and a lower insulating ring 60, each formed of a resin, are disposed, respectively.

However, as the structure of the lithium secondary battery other than the winding type electrode group, a known structure may be used without any particular limitation.

### EXAMPLE 1

Hereinafter, the lithium secondary battery according to the present disclosure will be described in more detail with reference to Examples and Comparative Examples. However, the present disclosure is not limited to the following Examples.

[Formation of Positive Electrode]

After a rock salt type lithium transition metal oxide (NCA; positive electrode active material) containing Li, Ni, Co, and Al (Li molar ratio to the total of Ni, Co, and Al: 1.0) and having a layered structure, an acetylene black (AB; electrically conductive material), and a poly(vinylidene fluoride) (PVdF; binding material) were mixed together at a weight ratio of NCA: AB: PVdF=95: 2.5: 2.5, an appropriate amount of N-methyl-2-pyrollidone (NMP) was further added to the mixture thus formed and stirred, so that a positive electrode mixture slurry was prepared.

After the positive electrode mixture slurry thus obtained was applied on two facing surfaces of Al foil (positive electrode collector), the coating films of the positive electrode mixture thus formed were dried and then rolled using a roller machine. A laminate of the positive electrode collector and the positive electrode mixture thus obtained was cut into a predetermined electrode size, so that a positive electrode including the positive electrode mixture layers on the two facing surfaces of the positive electrode collector was obtained.

In addition, in a part of the region of the positive electrode, an exposed portion of the positive electrode collector at which the positive electrode mixture layer was not provided was formed. To the exposed portion of the positive electrode collector, one end portion of an aluminum-made positive electrode lead was fitted by welding.

[Formation of Negative Electrode]

Electrolytic copper foil (thickness: 10 μm) was cut into a predetermined electrode size, so that a negative electrode (negative electrode collector) was formed. To the negative electrode collector, one end portion of a nickel-made negative electrode lead was fitted by welding.

[Preparation of Electrolyte]

After 4-fluoroetylene carbonate (FEC), ethyl methyl carbonate (EMC), and dimethyl carbonate (DMC) were mixed together at a volume ratio of FEC: EMC: DMC=20: 5: 75, LiPF₆ was added to the mixed solvent thus formed to have a concentration of 1 mol/L, so that an electrolyte was prepared.

Furthermore, lithium iodide (LiI) was added to the nonaqueous electrolyte. A content of LiI in the electrolyte was set to 1 percent by weight.

[Battery Assembly]

In an inert gas atmosphere, the positive electrode and the negative electrode collector were spirally wound with polyethylene-made separators (fine porous films) interposed therebetween, so that an electrode group was formed.

After the electrode group was received in a bag-shaped exterior body formed of a laminate sheet including an Al layer, and the electrolyte described above was injected therein, the exterior body was sealed. As described above, a battery Al was formed. In addition, when the electrode group was received in the exterior body, the other end portion of the positive electrode lead and the other end portion of the negative electrode lead were exposed to the outside of the exterior body.

[Evaluation]

The battery Al was evaluated by a charge/discharge test.

According to the charge/discharge test, in a temperature-constant oven at 25° C., a cycle in which the battery was charged under the following conditions and then discharged under the conditions described below with a rest for 20 minutes interposed therebetween was performed 100 times.

[Charge]

After a constant current charge was performed at a current density of 2 mA/cm² at the positive electrode until a battery voltage reached 4.3 V, a constant voltage charge was performed at a voltage of 4.1 V until the current density reached 1 mA/cm².

[Discharge]

A constant current discharge was performed at a current density of 2 mA/cm² at the positive electrode until the battery voltage reached 3V.

A ratio (C2/C1×100) of a discharge capacity C2 at a 100th cycle to a discharge capacity C1 at a first cycle was obtained as a capacity retention rate at the 100th cycle.

### EXAMPLE 2

Except for that lithium bromide (LiBr) was added to the mixed solvent instead of LiI, by a method similar to that of Example 1, a battery A2 was formed and evaluated.

### EXAMPLE 3

Except for that lithium difluoro(oxalate)borate was further added to the mixed solvent to have a concentration of 0.5 mol/L, by a method similar to that of Example 1, a battery A3 was formed and evaluated.

### EXAPLE 4

Except for that lithium difluoro(oxalate)borate was further added to the mixed solvent to have a concentration of 0.5 mol/L, by a method similar to that of Example 2, a battery A4 was formed and evaluated.

### COMPARATIVE EXAMPLE 1

Except for that no LiI was added to the electrolyte, by a method similar to that of Example 1, a battery B1 was formed and evaluated.

### COMPARATIVE EXAMPLE 2

Except for that no FEC was used, and a solvent in which EC and EMC were mixed at a volume ratio of EC: DMC=3: 7 was used, by a method similar to that of Example 1, a battery B2 was formed and evaluated.

### COMPARATIVE EXAMPLE 3

Except for that LiI was added to the electrolyte to have a content of 0.1 percent by weight, by a method similar to that of Example 1, a battery B3 was formed and evaluated.

### COMPARATIVE EXAMPLE 4

Except for that LiI was added to the electrolyte to have a content of 10 percent by weight, by a method similar to that of Example 3, a battery B4 was formed and evaluated.

TABLE 1

| | | | AMOUNT | | | |
|---|---|---|---|---|---|---|
| | | | OF | | | |
| | | | LITHIUM | | | |
| | | | HALO- | | | |
| | | | GENATED | | | 100 cyc |
| | | LITHIUM | COMPOUND | | | DISCHARGE |
| | | HALO- | (PERCENT | | LiBF₂ | CAPACITY |
| | BATTERY | GENATED | BY | FEC | (C₂O₄) | RETENTION |
| | No | COMPOUND | WEIGHT) | (vol %) | (mol/L) | RATE (%) |
| EXAMPLE 1 | A1 | LiI | 1 | 20 | 0 | 36.5 |
| EXAMPLE 2 | A2 | LiBr | 1 | 20 | 0 | 42.5 |
| EXAMPLE 3 | A3 | LiI | 1 | 20 | 0.5 | 71.5 |
| EXAMPLE 4 | A4 | LiBr | 1 | 20 | 0.5 | 80.5 |
| COMPARATIVE | B1 | LiI | 0 | 20 | 0 | 8.9 |
| EXAMPLE 1 | | | | | | |
| COMPARATIVE | B2 | LiI | 1 | 0 | 0 | 0 |
| EXAMPLE 2 | | | | | | |
| COMPARATIVE | B3 | LiI | 0.1 | 20 | 0 | 18.4 |
| EXAMPLE 3 | | | | | | |
| COMPARATIVE | B4 | LiI | 10 | 20 | 0.5 | 0 |
| EXAMPLE 4 | | | | | | |

Compared to B1 in which the lithium halogenated compound was not added and B2 in which FEC was not used, A1 and A2 in each of which the electrolyte containing the lithium halogenated compound and FEC was used had a high 100 cyc discharge capacity retention rate. Compared to A1 and A2 in each of which FEC was only added, in A3 and A4 in each of which FEC and lithium difluoro(oxalate)borate were used in combination, the 100 cyc discharge capacity retention rate was further improved.

According to Battery B3, since the lithium halogenated compound was added only to have a content of 0.1 percent by weight, for example, a dendrite precursor was not sufficiently dissolved, and a dendrite-shaped precipitate was believed to extend, so that the 100 cyc discharge capacity retention rate was decreased.

According to battery B4, since the lithium halogenated compound was added to have a content of 10 percent by weight, a self-discharge occurred, and hence, the 100 cyc discharge capacity retention rate was decreased.

### INDUSTRIAL APPLICABILITY

The lithium metal secondary battery according to the present disclosure may be used for a mobile phone, a smartphone, an electronic device, such as a tablet, an electric vehicle including a hybrid vehicle and a plug-in-hybrid vehicle, a household storage battery in combination with a solar cell, and the like.

### REFERENCE SIGNS LIST

10 positive electrode

11 positive electrode mixture layer

12 positive electrode collector

13 positive electrode lead

14 positive electrode terminal

20 negative electrode

21 negative electrode collector

25 negative electrode lead

22 lithium ions

23 lithium metal

24 fluorine-containing film

30 electrolyte

40 separator

50 winding type electrode group

60 lower insulating ring

61 upper insulating ring

70 battery case

80 sealing plate

100 lithium metal secondary battery

1. A lithium metal secondary battery comprising:
a positive electrode including a positive electrode active material which contains a lithium transition metal oxide;
a negative electrode which is disposed to face the positive electrode, which includes a negative electrode collector, and on which a lithium metal is precipitated in charge;
a separator disposed between the positive electrode and the negative electrode; and
an electrolyte which is impregnated in the separator and which contains a lithium halogenated compound in an amount of more than 0.1 to less than 10 percent by weight and at least one selected from a fluorinated cyclic carbonate and a fluorinated oxalate complex.

2. The lithium metal secondary battery according to claim 1,
wherein the fluorinated cyclic carbonate is contained in an amount of 8 to 30 percent by volume with respect to the volume of the electrolyte.

3. The lithium metal secondary battery according to claim 1,
wherein the fluorinated cyclic carbonate is 4-fluoroethylene carbonate.

4. The lithium metal secondary battery according to claim 1,
wherein with respect to the total of the electrolyte, the fluorinated oxalate complex is contained at a concentration of 0.01 to 1 mol/L.

5. The lithium metal secondary battery according to claim 1,
wherein the fluorinated oxalate complex is at least one selected from lithium difluoro(oxalate)borate, lithium tetrafluoro(oxalate)phosphate, and lithium difluorobis(oxalate)phosphate.

6. The lithium metal secondary battery according to claim 1,
wherein the lithium halogenated compound is at least one selected from lithium iodide and lithium bromide.

7. The lithium metal secondary battery according to claim 1,
wherein a lithium metal is precipitated on the negative electrode in charge, and in discharge, the lithium metal is dissolved from the negative electrode into the electrolyte.

8. The lithium metal secondary battery according to claim 1,
wherein the negative electrode collector is copper foil or copper alloy foil.
